(19) United States
(12) Patent Application Publication
(10) Pub. No.: US 2017/0185282 A1
(43) Pub. Date: Jun. 29, 2017

(54) GESTURE RECOGNITION METHOD FOR A TOUCHPAD

(71) Applicant: ELAN MICROELECTRONICS CORPORATION, Hsin Chu (TW)

(72) Inventors: Chien-Chou CHEN, Taipei City (TW); Yu-Hao CHEN, New Taipei City (TW)

(73) Assignee: ELAN MICROELECTRONICS CORPORATION, Hsin Chu (TW)

(21) Appl. No.: 15/389,736

(22) Filed: Dec. 23, 2016

Related U.S. Application Data
(60) Provisional application No. 62/272,036, filed on Dec. 28, 2015.

(30) Foreign Application Priority Data
Dec. 2, 2016 (TW) 105139882

(51) Int. Cl. G06F 3/0488; G06F 3/0485; G06F 3/0481

(52) U.S. Cl. CPC G06F 3/04883; G06F 3/04812; G06F 3/0485

(57) ABSTRACT

A gesture recognition method has steps of detecting a first number of first objects touching a touchpad, detecting a second number of second objects tapping the touchpad when the first number of first objects still touches the touchpad, determining that a shortest distance between the first number of first objects and the second number of second objects is less than a preset spacing distance, and enabling a gesture function. Accordingly, gestures provided through the foregoing gesture recognition method are advantageous in being user-friendly, relaxed, convenient and smooth in operation.

### BACKGROUND OF THE INVENTION

1. Field of the Invention

The present invention relates to a recognition method and, more particularly, to a gesture recognition method for a touchpad.

2. Description of the Related Art

Touchpads or trackpads have been extensively applied to electronic products, such as notebook computers, personal digital assistants (PDA), mobile phones and other electronic devices.

A drag function is usually used to move objects displayed on a screen or to define a range. A commonly used drag gesture on a touchpad is to tap the touchpad with one finger and then touch the touchpad (usually called a 1½ tap). Then a drag function is performed according to the finger movement on the touchpad. The disadvantage of the drag gesture comprises high failure rate and high learning difficulty.

Generally, the area of touchpads configured in laptop computers or external touchpads is limited. If objects on the screen need to be moved for a longer distance or a larger range needs to be defined, user has to repeat the drag gesture many times.

### SUMMARY OF THE INVENTION

An objective of the present invention is to provide a gesture recognition method with advantages of being easy to learn and having a high success rate.

To achieve the foregoing objective, the gesture recognition method for a touchpad comprises:

(a) detecting a first number of first objects touching the touchpad;

(b) detecting a second number of second objects tapping the touchpad when the first number of first objects still touches the touchpad;

(c) determining that a shortest distance between the first number of first objects and the second number of second objects is less than a preset spacing distance; and

(d) enabling a gesture function after the step (c).

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of operation of a gesture on a touchpad in accordance with the present invention;

FIG. 2 is a flowchart of a first embodiment of the gesture recognition method for a touchpad in accordance with the present invention;

FIG. 3 is a flowchart of a second embodiment of the gesture recognition method for a touchpad in accordance with the present invention;

FIG. 4 is a flowchart of a third embodiment of the gesture recognition method for a touchpad in accordance with the present invention;

FIG. 5 is a flowchart of a fourth embodiment of the gesture recognition method for a touchpad in accordance with the present invention;

FIG. 6 is a flowchart of a fifth embodiment of the gesture recognition method for a touchpad in accordance with the present invention, comprising a step of detecting the termination gesture; and

FIG. 7 is a complete flowchart of the gesture recognition method for a touchpad in accordance with an embodiment of the present invention.

### DETAILED DESCRIPTION OF THE INVENTION

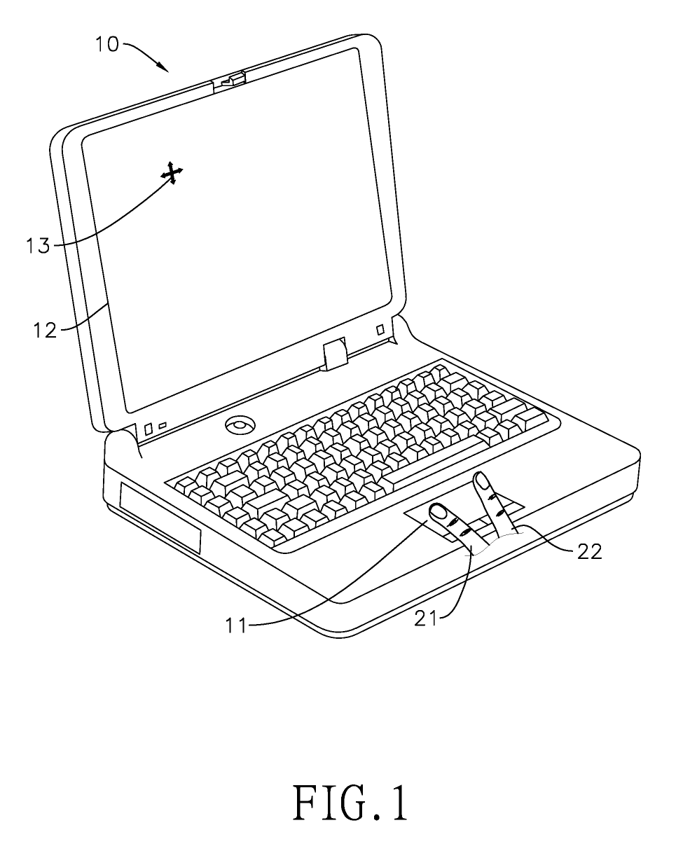

The present invention discloses a gesture recognition method for a touchpad and is applied to enable a gesture function. With reference to FIG. 1, such gesture function is performed on a touchpad 11, wherein the touchpad may be mounted on an electronic device 10. The electronic device 10 may be, but not limited to, a laptop computer. The electronic device 10 is equipped with a display 12 that displays a cursor 13. Manipulations of user's fingers 21 or 22 on the touchpad 11 may control movement of the cursor 13. The touchpad 11 may be a capacitive touchpad, a resistive touchpad, an optical touchpad or a piezoelectric touchpad.

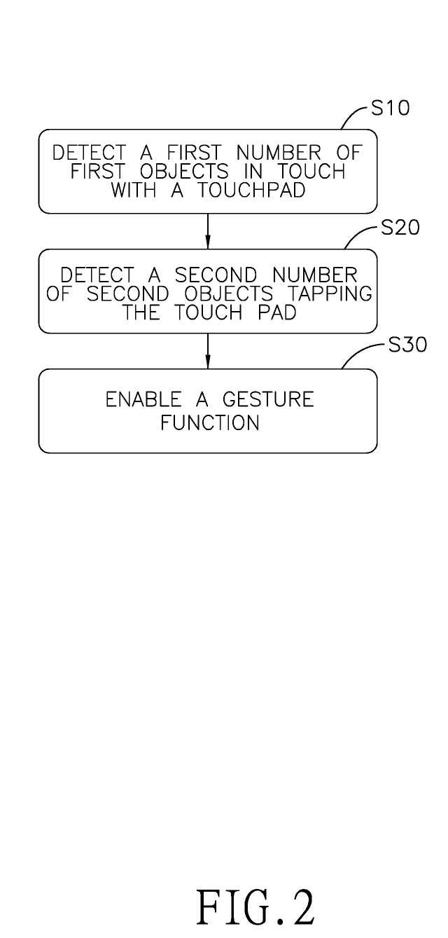

With reference to FIG. 2, a first embodiment of a gesture recognition method for a touchpad in accordance with the present invention is shown. To facilitate the following description in a clear way, an example that an user uses a touchpad of a laptop computer is given. In the example, the gesture recognition method in accordance with the present invention is performed by a processing unit. The processing unit is used to process gesture inputs on the touchpad 11 and perform functions corresponding to the gesture inputs. The processing unit may comprise one or multiple elements, such as CPU of the laptop computer and/or the controller of the touchpad and the like.

In step S10, the processing unit detects a first number of first objects touching a touchpad. The first number is a positive integer greater or equal to 1. In one embodiment, the first object may be a conductor, such as a finger, performing operations on a capacitive touchpad. The name and the quantity of the first object as described above are not intended to be limitations of the present invention and are for the purpose of easy and clear description.

In step S20, the processing unit detects a second number of second objects tapping the touchpad while the first number of first objects remain on the touchpad. The second number is a positive integer greater than or equal to 1. In one embodiment, the second object may be a conductor, such as a finger, performing operations on the capacitive touchpad. The tap gesture comprises actions of contacting and leaving the touchpad. It is known to persons with ordinary skill in the related art of the present invention that many methods are available to recognize a tap gesture and are therefore not discussed here. The name and the quantity of the second object as described above are not intended to be limitations of the present invention and are for the purpose of easy and clear description.

After detecting the first number of first objects touching the touchpad and the second number of second objects tapping the touchpad, the processing unit enables a gesture function in step S30. In other words, the definition of the gesture of the foregoing embodiment is the first number of first objects touching the touchpad and then the second number of second objects tapping the touchpad while the first number of first objects remain on the touchpad. Under normal circumstance, user performs gesture operation by one hand, and the sum of the first number and the second number is not greater than 5.

The gesture recognition method of the present invention has a wide scope of application. The gesture function may be a drag function for moving a target object, such as a file icon, selected by the cursor, or for defining a selected range according to movement of the cursor to select multiple files or a section of text. The gesture function may be a scroll function used to scroll contents displayed on the display 12. The gesture function may be a file-open function or a file-delete function.

In an embodiment according to FIG. 2, both the first number and the second number are 1, the first object and the second object are fingers, and the gesture function is the drag function. In this embodiment, the user may touch the touchpad with an index finger (i.e. the first object) and then tap the touchpad with a middle finger (i.e. the second object) to enable the drag function. In other words, the drag gesture will be recognized till the second object (middle finger) completes the action of tapping the touchpad so as to enable the drag function. Subsequently, the drag function is performed according to movement of the finger (index finger) remaining on the touchpad. In this embodiment, the drag gesture is performed with one finger touching the touchpad and then another finger tapping the touchpad. Therefore, the drag gesture is very easy to learn.

The conventional drag gesture is performed by 1½ tap. After the finger moves the cursor to the position of an object to be moved, the finger must be lifted from the touchpad, and then the finger sequentially performs actions of put down, lift up and put down to complete the 1½ tap. The entire action of the 1½ tap requires lifting the finger twice and putting down the finger twice. The wrist also sways up and down twice along with the finger's action. Under the circumstance of frequently using the 1½ tap, joints of the finger and the wrist may become uncomfortable.

According to the drag gesture of the present invention, after one finger moves the cursor to the position of an object to be moved, the finger does not have to be lifted from the touchpad. The next step required to enable the drag function is to use another finger (for example a neighboring finger) to tap the touchpad. The whole action of the drag gesture does not need to sway wrist. In contrast to the conventional 1½ tap, the drag gesture of the present invention has 50% less finger motion and no swaying action of the wrist joint. The burden on the finger and the wrist joint will be significantly reduced. For users frequently performing the drag gesture on the touchpad for a long time, the drag gesture in accordance with the present invention is definitely a better choice.

In one embodiment, when the drag function is enabled, the processing unit may change the appearance of the cursor to a preset appearance representing the drag function to help the user to easily recognize the drag function being performed on the touchpad. For example, when the drag function is enabled, the processing unit may change the appearance of the cursor 13 from a single-headed arrow to, but not limited to, a four-way-arrow as shown in FIG. 1.

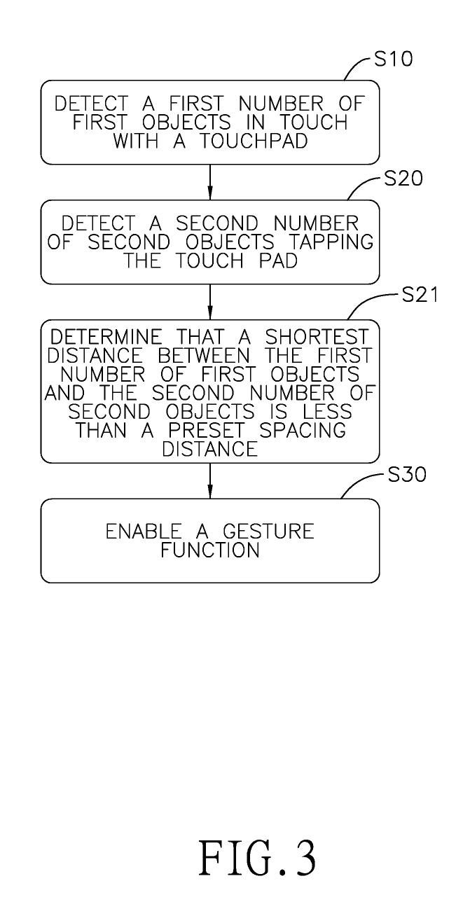

With reference to FIG. 3, a second embodiment of the gesture recognition method for a touchpad in accordance with the present invention is shown. The second embodiment differs from the first embodiment in that the second embodiment further comprises a step S21 after the step S20. The step S21 is to determine whether a shortest distance between the first number of first objects and the second number of second objects while the second number of second objects tap the touchpad is less than a preset spacing distance. After the step S21, the step 30 of enabling the gesture function is performed. In one embodiment, the shortest distance may be taken as a shortest distance between one of the first objects and a nearest one of the second objects. For example, the first number is 1 and the second number is 1, when the second object taps the touchpad, the position tapped by the second object on the touchpad is detected as P2 and the position of the first object on the touchpad is detected as P1. P1 and P2 can be used to calculate the shortest distance between the first object and the second object. When the shortest distance is less than the preset spacing distance, the gesture function is enabled.

In another embodiment, the first number is greater than or equal to 2 and/or the second number is greater than or equal to 2. When the second number of second objects tap the touchpad, the position of one of the first number of first objects that is most adjacent to the second number of second objects is detected as P1. The position of one of the second number of second objects that is most adjacent to the first number of first objects is detected as P2. The shortest distance between the first number of first objects and the second number of second objects can be determined by the positions of P1 and P2 on the touchpad. When the shortest distance is less than the preset spacing distance, the gesture function is enabled. The gesture function as shown in FIG. 3 may be one of the drag function, the scroll function, the file-open function and the file-delete function.

In one embodiment, the preset spacing distance may be determined according to a reasonable distance between two adjacent fingers of a hand, for example 3 centimeters. In one embodiment, if the shortest distance between the first number of first objects and the second number of second object is greater than the preset spacing distance, a function corresponding to a tapping of the second number of second objects is performed instead of the gesture function. The determination of the shortest distance between the first object and the second object in step S21 can reduce a possibility of false enable of the gesture function. For example, under certain circumstance, users may use the index finger of the right hand to perform the tap gesture while the thumb of the left hand inadvertently rests on the touchpad. If the position tapped by the index finger of the right hand on the touchpad is far enough from the thumb of the left hand, the gesture function will not be enabled according to the determination in FIG. 3. Therefore, the possibility of false enable of the gesture function is reduced. When the shortest distance between the first object and the second object is equal to the preset spacing distance, the gesture function may be enabled in one embodiment or may not be enabled in another embodiment.

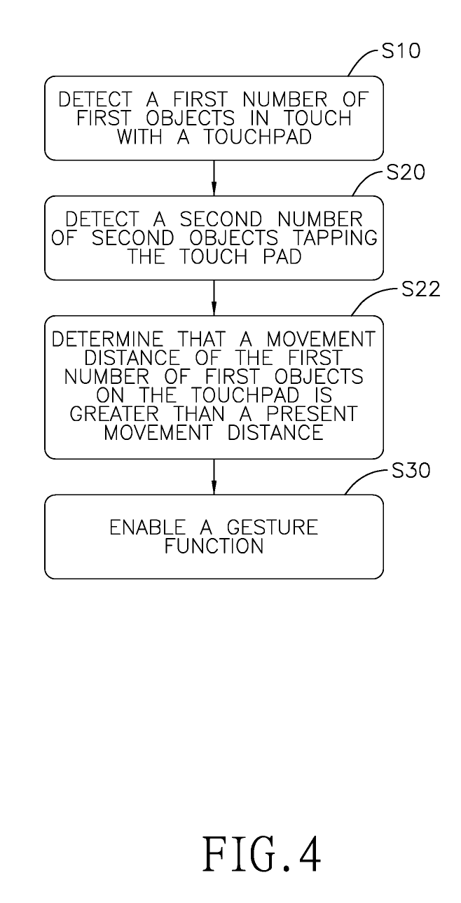

With reference to FIG. 4, a third embodiment of the gesture recognition method for a touchpad in accordance with the present invention is shown. The third embodiment differs from the first embodiment in that the third embodiment further comprises a step S22 of determining that an movement distance of the first number of first objects is greater than a preset movement distance on the touchpad after the step S20. After the step S22, the step S30 of enabling the gesture function is performed. In one embodiment, the preset movement distance is, but not limited to, 0.15 centimeter. The gesture function as shown in FIG. 4 may be a drag function or a scroll function. By determining whether the movement distance of the first number of the first object is greater than the preset movement distance in step s22, the possibility of false enable of the gesture function is reduced. For example, under certain circumstance, users may use the index finger of the right hand to perform the tap gesture while the thumb of the left hand inadvertently rests on the touchpad. After the tapping of the index finger, if the thumb of the left hand does not move a distance greater than the preset movement distance, the gesture function will not be enabled according to the embodiment of FIG. 4. Therefore, the possibility of false enable of the gesture function can be reduced.

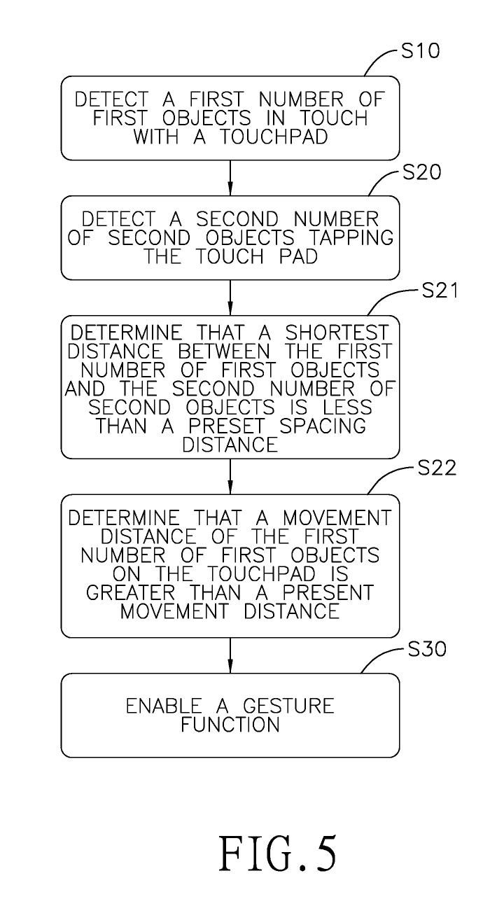

With reference to FIG. 5, a fourth embodiment of the gesture recognition method for a touchpad in accordance with the present invention is shown. The fourth embodiment differs from the first embodiment in that the fourth embodiment further comprises a step S21 in FIG. 3 and a step S22 sequentially performed after step S20 in FIG. 4. After the steps S21 and S22, the gesture function in step S30 is enabled. The relevant descriptions and effectiveness of steps S21 and S22 have been discussed in foregoing FIGS. 3 and 4, and therefore are omitted here.

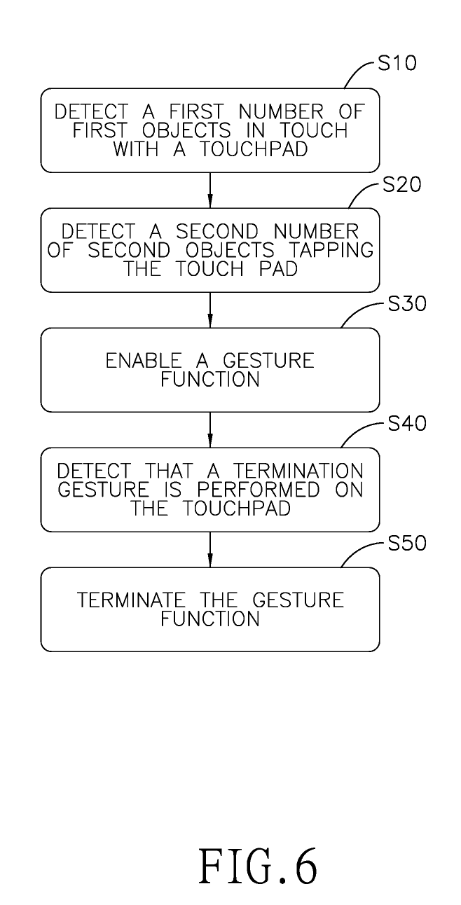

With reference to FIG. 6, after the step S30 of enabling the gesture function, if the processing unit detects a termination gesture performed on the touchpad (step S40), a step S50 of terminating the gesture function is performed. Steps S40 and S50 may be applied to any of the embodiments in FIGS. 2 to 5. The termination gesture may comprise, but not limited to, a tap gesture. In one embodiment, the termination gesture is identified if the tap gesture, such as single-finger tap gesture or multi-finger tap gesture, is detected on the touchpad and the first object still touches the touchpad. In another embodiment, the termination gesture is identified if the tap gesture is detected on the touchpad after the first object leaves the touchpad.

According to the embodiment of FIG. 6, the gesture function is not terminated until the termination gesture is detected. In one embodiment, after the gesture function is enabled, even if the first object leaves the touchpad, the touchpad is still operated under a mode corresponding to the gesture function, and if an object (e.g., the first object) subsequently touches and moves on the touchpad, an action corresponding to the gesture function is continuously performed. Taking the drag function as an example, such feature is beneficial to drag operation over a long distance or a large area without needing to repeat the drag gesture, and is convenient for users. Because the drag function is maintained, drag operation over a long distance or a large area is feasible and is not subject to limited size of the touchpad, and the area and cost taken by the touchpad can be reduced.

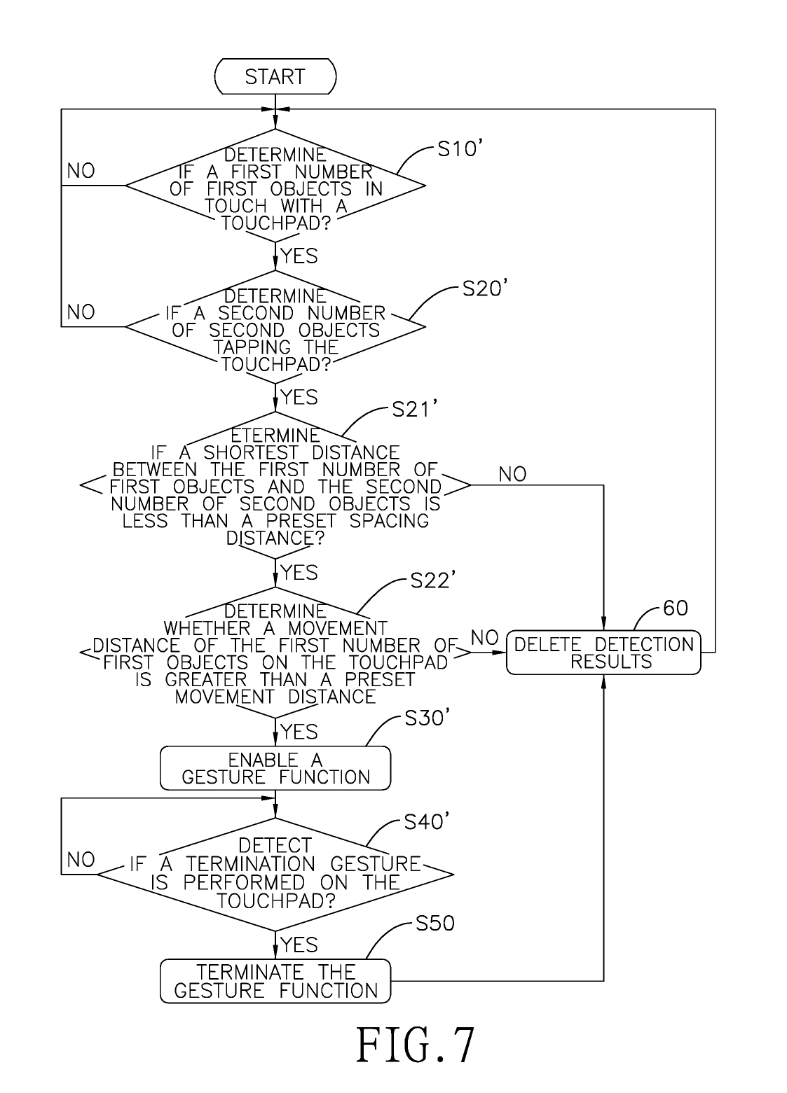

With reference to FIG. 7, a complete flowchart in accordance with an embodiment of the present invention is shown. To facilitate the following description in a clear way, an example that users use a touchpad of a laptop computer is given.

The step S10′ is to detect whether a first number of first objects touch a touchpad. If there is no first number of first objects touching the touchpad, return to the step S10′. If there is the first number of first objects touching the touchpad, a next step S20′ is performed. The step S20's is to detect whether a second number of second objects tap the touchpad. If there is no second number of second objects tapping the touchpad, return to the step S10′. If there is the second number of second objects tapping the touchpad, a next step S21′ is performed. The step of S21′ is to determine whether a shortest distance between the first number of first objects and the second number of second objects is less than a preset spacing distance.

If the shortest distance between the first number of first objects and the second number of second objects is less than the preset spacing distance, perform a next step S22′. The step S22′ is to determine whether a movement distance of the first objects on the touchpad is greater than a preset movement distance.

If the shortest distance between the first number of first objects and the second number of second objects is greater than or equal to the preset spacing distance, perform a step S60 to clean the detected information and then return to the step S10′ to detect objects operated on the touchpad. If the first object does not move a distance greater than the preset movement distance, perform the step S60 to clean the detecting information and return to the step S10′ to detect objects operated on the touchpad. In one embodiment, the step S60 is to clean detected information of the first object and the second object, for example, the numbers of the first object and the second object, the touched or tapped positions, a movement distance or the like. If the movement distance of the first object is greater than a preset movement distance, the next step S30 of enabling a gesture function is performed.

After the gesture function is enabled, the step S40′ is performed. The step S40′ is to determine whether a termination gesture operated on the touchpad is detected. If the termination gesture is not detected, return to the step S40′. If the termination gesture is detected, perform the steps S50 and S60 and return to the step S10′.

In one embodiment, the step S30 of enabling the gesture function may comprise providing a signal indicating that a gesture corresponding to the gesture function is detected so as to inform an operating system (OS) of the electronic device 10 to perform the gesture function. In one embodiment, the step S50 may comprise providing a signal indicating the termination gesture for informing the OS of the electronic device 10 to terminate the gesture function.

All steps of the embodiments shown in FIGS. 2 to 7 may be completely performed by the CPU of the electronic device 10, such as a laptop computer, or by the controller of the touchpad 11. Alternatively, a part of the steps of the embodiments in FIGS. 2 to 7 may be performed by the CPU and the rest of steps may be performed by the controller of the touchpad 11. Moreover, the gesture function in the embodiments of FIGS. 2 to 7 may be a drag function, a scroll function, a file-open function or a file-delete function. After the gesture function is enabled, a window-based user interface of the electronic device 10 enters an operation mode. Under the operation mode, position information of the first object on the touchpad 11 is constantly transmitted to the CPU of the electronic device 10 or the controller of the touchpad 11 to perform the gesture function. It is practicable to apply the foregoing embodiments to an external touchpad connected to the electronic device 10 through wired connection or wireless connection.

For conventional multi-finger gestures, movement of multiple fingers on a touchpad in a same direction or opposite directions may correspond to different gesture functions, such as page scroll, image zoom in and zoom out, and the like. According to the present invention, enabling a specific gesture function requires the second number of second objects to complete tapping the touchpad, and the specific gesture function will not be enabled when the second number of second objects only touch the touchpad. Therefore, the present invention avoids confusion or conflict with the existing multi-finger gestures.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A gesture recognition method for a touchpad, the method comprising steps of:
(a) detecting a first number of first objects touching the touchpad;
(b) detecting a second number of second objects tapping the touchpad when the first number of first objects on the touchpad;
(c) determining that a shortest distance between the first number of first objects and the second number of second objects is less than a preset spacing distance; and
(d) enabling a gesture function after the step (c).

2. The gesture recognition method as claimed in claim 1, before the step (d), the method further comprising a step of:
determining that a movement distance of the first number of first objects on the touchpad is greater than a preset movement distance.

3. The gesture recognition method as claimed in claim 1, wherein the gesture function is one of a drag function, a scroll function, a file-open function and a file-delete function.

4. The gesture recognition method as claimed in claim 2, wherein the gesture function is one of a drag function and a scroll function.

5. The gesture recognition method as claimed in claim 3, wherein the drag function comprises moving a target object selected by a cursor.

6. The gesture recognition method as claimed in claim 4, wherein the drag function comprises moving a target object selected by a cursor.

7. The gesture recognition method as claimed in claim 3, wherein the drag function comprises defining a selecting range according to a movement of a cursor.

8. The gesture recognition method as claimed in claim 4, wherein the drag function comprises defining a selecting range according to a movement of a cursor.

9. The gesture recognition method as claimed in claim 1, wherein when the gesture function is enabled, the method further comprises:
changing an appearance of a cursor.

10. The gesture recognition method as claimed in claim 2, wherein when the gesture function is enabled, the method further comprises:
changing an appearance of a cursor.

11. The gesture recognition method as claimed in claim 1, after the step (d), the method further comprising a step of:
detecting a termination gesture, wherein the gesture function is terminated after the termination gesture performed on the touchpad is detected.

12. The gesture recognition method as claimed in claim 2, after the step (d), the method further comprising a step of:
detecting a termination gesture, wherein the gesture function is terminated after the termination gesture performed on the touchpad is detected.

13. The gesture recognition method as claimed in claim 11, wherein the termination gesture comprises a tap gesture.

14. The gesture recognition method as claimed in claim 12, wherein the termination gesture comprises a tap gesture.
